(19) United States
(12) Patent Application Publication
(10) Pub. No.: US 2008/0294545 A1
(43) Pub. Date: Nov. 27, 2008

(54) Realty commission reinvestment system and method

(76) Inventor: Larry Shane Langdale, Mt. Pleasant, SC (US)

Correspondence Address: Larry Shane Langdale, Suite 14-C, 1041 Johnnie Dodds Boulevard, Mt. Pleasant, SC, 29464, US

(21) Appl. No.: 11/805,478

(22) Filed: May 23, 2007

(51) Int. Cl. G06Q 40/00

(52) U.S. Cl. 705/38

(57) ABSTRACT

A system and method for reinvesting realty commissions includes the steps of: a) Offering the system commission reinvestment program to a client who is listing or interested in purchasing a real estate property using a system realty company; b) Fixing a rebate amount of the real estate commission that will be transferred to the system realty company once the real estate property is purchased or sold using an agent of the system realty company, and then rebated back to the client at the end of a pre-set first time period; c) Presenting a first system contract to the client; d) Reviewing and executing the first system contract; and e) Transferring the rebate amount of the commission from the sale or purchase of the real estate property to a system corporate bank account, and a remainder of the pre-agreed commission to the agent of the system realty company on or after the closing.

### BACKGROUND OF THE INVENTION

1. Technical Field

The present invention relates to a business method and system for reinvesting realty commissions.

2. Background Information

Traditionally, real estate agents are paid a commission when they help a buyer or seller to purchase or sell real estate property. Once the closing attorney sends a check for the commission to the real estate agent, the relationship between the buyer or seller and the real estate agent is usually concluded.

With the real estate commission reinvestment system and method of the present invention, the buyer/seller client and the real estate agent can designate an agreed upon percentage of the commission for deposit in a corporate bank account for investment by the real estate corporation for a pre-set period of time. The percentage can range from about 1% to about 100% of the real estate commission. The percentage of the commission and the investment time period can be negotiated at the time of the listing agreement between the buyer/seller client and the system realty company. For the buyer/seller client who does not select this option, the commission is paid to the agent in the traditional manner and the client/agent relationship ends as usual. At the end of the investment time period, the buyer/seller client who does select this option receives a rebate plus any interest that has accrued on the rebate amount. Alternatively, the buyer or seller client may be offered the opportunity by the system realty corporation to enter one or more additional investment time periods. The rebate amounts from participating clients are pooled in the corporate bank account, which forms a fund that can be invested in real estate properties that will hopefully produce a profit over the investment time period. In this way, both the system realty corporation and the participating clients benefit. The present system and method offer a buyer or seller client the opportunity to possibly receive some or all of the real estate commission back at the end of the pre-determined time period.

### BRIEF SUMMARY OF THE INVENTION

The present invention is a realty commission reinvestment business method and system. The real estate commission reinvestment method comprises the following steps:

a) Offering a commission reinvestment program according to the real estate commission reinvestment method to a client who is listing or interested in purchasing at least one real estate property using a system realty company;

b) Fixing a rebate amount of the real estate commission that will be transferred to the system realty company once the at least one real estate property is purchased or sold using at least one agent of the system realty company, and then rebated back to the client at the end of a pre-set first time period;

c) Presenting a first system contract to the client;

d) Reviewing and executing the first system contract; and

e) Transferring the rebate amount of the commission from the sale or purchase of the at least one real estate property to a system corporate bank account, and a remainder of the pre-agreed commission to the at least one agent of the system realty company on or after a closing on the at least one real estate property.

The real estate commission reinvestment system includes: a) a policy concerning investment of pooled rebate amounts from the sale or purchase of at least one real estate property in select real estate investment projects, and obtaining additional, outside financing for the real estate investment projects; b) a system advertisement explaining the system commission reinvestment program; c) a first system contract; d) a corporate bank account; and e) an agreement with an independent, outside accounting firm for periodic audits of the corporate bank account.

### BRIEF DESCRIPTION OF THE SEVERAL VIEWS OF THE DRAWINGS

A more complete understanding of the invention and its advantages will be apparent from the following detailed description taken in conjunction with the accompanying drawings, wherein examples of the invention are shown, and wherein:

FIG. 1 is a flowchart of a realty commission reinvestment system/method according to the present invention;

FIG. 2 is a flowchart of a realty commission reinvestment system/method according to the present invention, continued from FIG. 1;

FIG. 3 is a flowchart of a realty commission reinvestment system/method according to the present invention, continued from FIG. 2;

FIG. 4 is a flowchart of a realty commission reinvestment method according to the present invention;

FIG. 5 is a flowchart of a realty commission reinvestment method according to the present invention;

FIG. 6 is a flowchart of a realty commission reinvestment method according to the present invention;

FIG. 7 is a flowchart of a realty commission reinvestment method according to the present invention; and

FIG. 8 is a flowchart of a realty commission reinvestment method according to the present invention.

### DETAILED DESCRIPTION OF THE INVENTION

In the following description, like reference characters designate like or corresponding parts throughout the several views. Also, in the following description, it is to be understood that such terms as “back,” “within,” and the like are words of convenience and are not to be construed as limiting terms. Referring in more detail to the drawings, the invention will now be described.

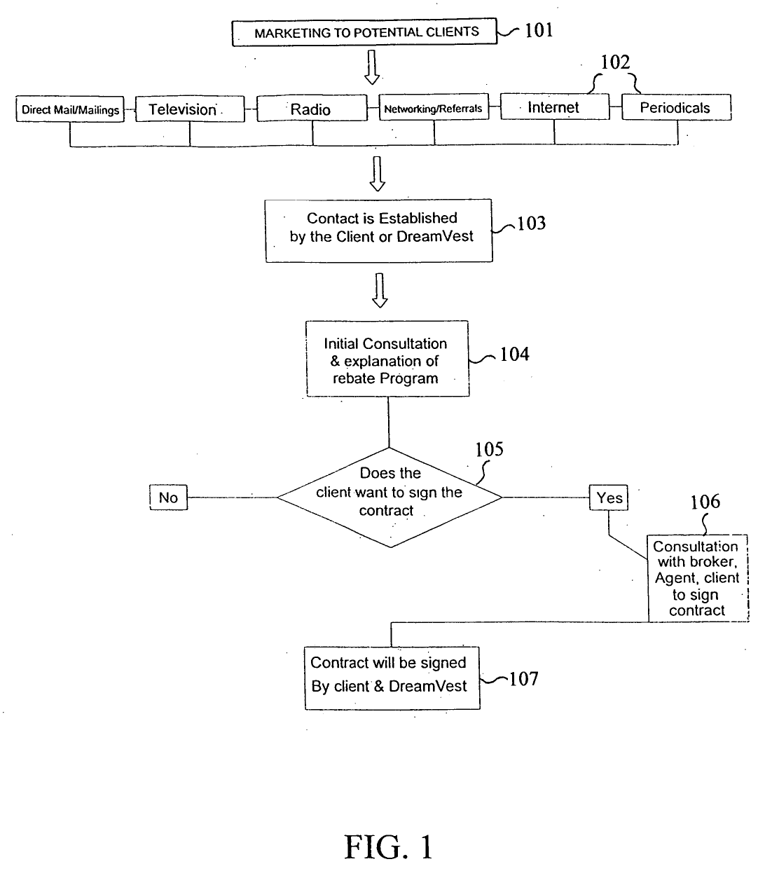

Turning first to FIGS. 1 through 3, a system 10 and method 20 for the reinvestment of commissions from the sale or purchase of real estate are depicted. Referring to FIG. 1, the real estate commission reinvestment system 10 is marketed to potential real estate customers (Block 101) through advertising via direct mail, television, radio, networking, referrals, the Internet, periodicals, etc., as shown in Block 102, and soliciting business directly from potential customers. Other suitable means of advertisement and marketing can also be used. The potential customer either contacts the system realty company 11, preferably DreamVest Realty, to inquire about buying or selling real estate property using the system realty company, or the system realty agent, preferably a DreamVest Realty agent, contacts the potential customer (see Block 103).

During an initial consultation, the system commission reinvestment program 12, also called the DreamVest rebate or commission reinvestment program here, is explained to the potential customer, normally by the system realty agent (Block 104). Real estate buyers and sellers often pay a commission to at least one realtor on the sale or purchase of the subject real estate property. With the system commission reinvestment program 12, the potential client is offered an opportunity to retain from about 1% to 100% of the real estate commission that is ordinarily paid to a realtor once a subject real estate property 19 is sold or purchased. Thus, a portion of the real estate commission 21 may be reinvested, or all of the commission 21 can be reinvested, as desired by the client and the system realty company 11.

Continuing with FIG. 1, if the potential client indicates interest in selling or buying real estate using the system realty company and the system commission reinvestment program 12 during the initial consultation or thereafter, the system realty agent negotiates the amount of the commission, what percentage of the commission will be rebated to the client at the end of a first time period 13, and the length of the first time period 13. These terms will be written into a first system contract 14, which is presented to the potential customer/client for review. Other required real estate-related documents, such as a listing agreement, seller's disclosure form, and/or a buyer agency form, are also presented to the client for review. For example, the system realty agent may give 25% of the commission that comes into the system realty company 11. The amount of the rebate 15 is based on the actual amount of commission received by DreamVest Realty rather than on the amount for the sale or purchase of the real estate. For example, if a 6% commission is agreed to by the seller client, and DreamVest Realty finds both the buyer and the seller, then the rebate 15 will be based on the entire 6%. If another real estate company finds the buyer, the client's rebate 15 will be based on 3% of the real estate contract price, assuming that the 6% commission is split 50/50 with the other real estate company.

If the potential client wishes to sign the first system contract 14 as shown in Block 105, a consultation is held between the DreamVest agent, the client, and optionally a real estate broker, as shown in Block 106, and the client either signs the contract as indicated in Block 107, or not. If the client and DreamVest Realty sign the first system contract 14, the client is provided with a copy of the signed first system contract 14. If the potential client does not sign the first system contract 14, the process halts and the commission cannot be reinvested.

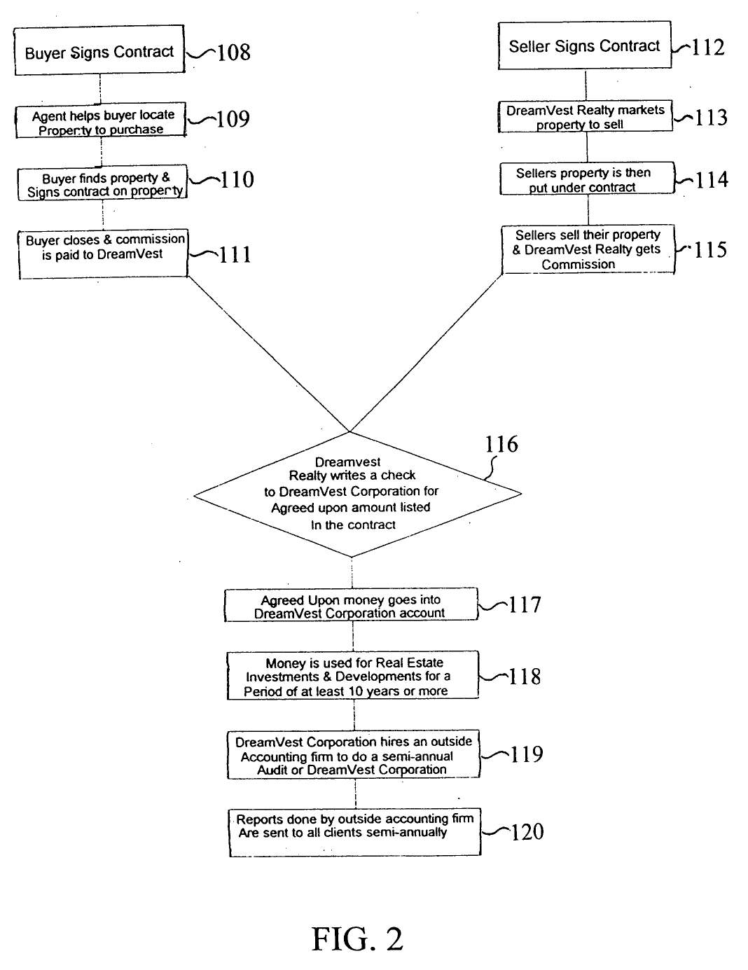

Turning to FIG. 2, the DreamVest agent assists the seller or buyer in the sale or purchase, respectively, of the real estate property 19 once the client's real estate property is listed with DreamVest Realty or a buyer's agreement has been signed by the client. Once a buyer client has signed the first system contract 14 as indicated in Block 108, the DreamVest agent helps the buyer client to locate suitable real estate property to purchase, as indicated in Block 109, according to the expressed desires of the client. The DreamVest agent ordinarily shows the client potential real estate properties and then assists the client in the transaction process once the client has selected a property 19 to buy. Once the buyer client finds a property he or she likes, the buyer signs a real estate contract on the property 19, as indicated in Block 110. The buyer client closes on the property and the agreed-upon commission 21 is paid to Dream Vest Realty, as indicated in Block 111. The client is encouraged to have a separate attorney review all contracts and other matters prior to signing.

Continuing with FIG. 2, where the client is a seller, the DreamVest agent first helps the seller client to locate suitable buyers once the seller client has signed the first system contract 14 as indicated in Block 112. Dream Vest Realty markets the real estate property to be sold, as shown in Block 113. Multiple Listing Services (MLS), newspaper advertisements, magazines, yard signs, and any other suitable means can be used to market the property. Eventually, the seller's property is put under contract, as indicated in Block 114. The seller client sells the real estate property 19, and the system realty company 11, preferably Dream Vest Realty, receives the agreed-upon real estate commission 21, as indicated in Block 115.

Continuing with FIG. 2, as the subject real estate property 19 closes, the system realty company 11, preferably DreamVest Realty, receives the real estate commission 21 from sale or purchase of the real estate property 19. The real estate sales commission 21 is divided with any outside real estate agent who contributed to the sale or purchase of the subject real estate property 19, as required. At a meeting with the client, the system realty agent explains that the real estate commission 21 belongs to the system realty company 11 for the work done in completing the real estate transaction.

Once the closing attorney sends a check for the commission 21 to the system realty company 11, the system realty company 11 (preferably DreamVest Realty) writes a check to the realty agent and the company handling the system reinvestment program 12, preferably DreamVest Corporation, as indicated in Block 116. The check to DreamVest Corporation is for the agreed-upon rebate amount 15 listed in the first system contract 14. The agreed-upon rebate percentage is deposited in the DreamVest corporate bank account 17, as seen in Block 117. The realty agent and the DreamVest corporate representative may be the same person. The system realty agent explains that the agreed-upon percentage 15 of the real estate commission 21 will be used to finance real estate investment and development projects, and that the remaining percentage of the commission 21 belongs to the system realty company 11. The corporate agent preferably also discusses a possible future rate of interest range with the client, though there is no way at the time of the meeting to predict the actual future rate of interest.

The portions of commissions designated by various DreamVest clients are pooled in the DreamVest corporate bank account 17. The pooled funds from the DreamVest corporate bank account 17 are invested in one or more real estate investment projects for the first time period, which is preferably at least 10 years as shown in Block 118. Investment decisions are at the sole discretion of authorized DreamVest employees and no consensus by the various clients is sought. It is explained to the clients in advance that they do not have input to fund real estate investment decisions. Information may be sent to the client concerning the estimated interest rate of return and what investments have been made with the commission percentage over the time period. Such real estate investments may include, for example, renovating homes or commercial properties, building homes or commercial properties, and developing real estate.

Before initiating the present system 10 and method 20, certain tasks are to be accomplished. These preliminary tasks, or steps, include the following: 1) prepare a brochure, flyer, newspaper advertisement, or other system advertisement 16 explaining the mechanics of the system rebate program 12 to potential customers; 2) prepare a first system contract 14, which includes clauses regarding the amount of the system rebate 15 and the first period of time 13 of the present program, preferably using one or more local attorneys, most preferably an attorney specializing in securities and a tax attorney; 3) prepare a handout for clients encouraging them to have a separate attorney review all contracts and other matters prior to signing them; 4) establish a dedicated DreamVest corporate bank account 17; and 5) retain an independent, outside accounting firm 18 to conduct audits, preferably semiannual or annual, of the DreamVest corporate bank account 17.

After closing, the independent, outside accounting firm 18 is asked to conduct audits of the corporate bank account 17, preferably semiannually or annually, as seen in Block 119 of FIG. 2. As depicted in Block 120, status reports 22 concerning the system program are prepared and sent to system clients, preferably by the independent outside accounting firm 18 on a semiannual or annual basis. Contact information is preferably included in the status report 22 in case the client has any questions. The system agent responds to any questions the system client may have, preferably within 24 hours. The rebate fund investments are also periodically monitored in-house, preferably on a quarterly or semi-annual basis.

Funds from the corporate bank account 17 can be moved from some real estate investment projects and re-invested in other real estate projects at the discretion of the program administrator 27, or other designated corporate manager, until the end of the first time period 13. The program administrator 27 may seek out and obtain additional, outside financing for the various real estate investment projects where considered necessary by the program administrator. Cash reserves and assets on hand as specified by the independent accounting firm 18 and in compliance with tax laws and regulations are retained in the fund.

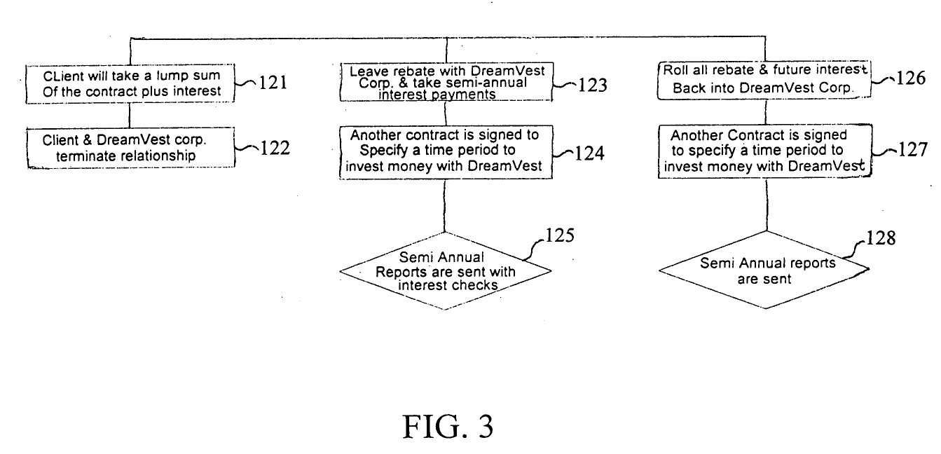

At the end of the first time period, the rebate 15 is offered to the client. The rebate 15 is an amount of money equal to the percentage of commission 21 that the system realty company, preferably DreamVest Realty, gave on the client's behalf to the client at the start of the first time period 13. The client has three choices in regard to the rebate, as depicted in Blocks 121, 123, and 126 in FIG. 3. These choices are preferably offered to the client between about nine months and about one month prior to the end of the time period. Where the time period is ten years, for example, these options are preferably presented to the client about 9.5 years after the date of execution of the first system contract 14.

First, the system client is offered the option of taking a lump sum, plus interest 23 (Block 121). This is the interest 23 that the rebate amount 15 has earned during the first time period 13. In this case, the relationship between the client and DreamVest Corporation terminates once the rebate 15 plus interest 23 is paid to the client, as seen in Block 122.

Secondly, the client has the option of leaving the rebate 15 in the corporate bank account 17 for a second time period 24 and receive periodic payments of any future interest 26 (Block 123). This is the interest 26 that the rebate amount 15 has earned during the previous six month period. The periodic interest payments on the rebate 15 are preferably made quarterly, semi-annually (most preferred), or annually. In this case, a second system contract 25 is prepared and provided to the client for consideration, as seen in Block 124. The second system contract 25 includes a clause specifying the second time period 24 during which the rebate amount 15 is invested by DreamVest Corporation (or whichever corporation has been designated) in real estate-related projects. The system representative and the client negotiate how long the second time period 24 will be. The second time period 24 is preferably five or ten years. The second system contract 25 also includes a clause concerning the interest 26 payments. Interest checks are periodically sent to the client according to the terms of the second system contract 25, as well as semi-annual or annual status reports 22, as seen in Block 125 of FIG. 3.

Thirdly, the client may choose to roll all of the rebate as well as future interest back into the DreamVest corporate bank account 17 (Block 126). In this case, a second system contract 25 is prepared and provided to the client for consideration, as seen in Block 127. The second system contract 25 includes a clause specifying the second time period 24 during which the rebate amount 15 is invested by DreamVest Corporation (or whichever corporation has been designated) in real estate-related projects. The second time period 24 is preferably five or ten years. Semi-annual or annual status reports 22 are sent to the client, as seen in Block 128 of FIG. 3.

Once the second period system contract 25 has been signed, the rebate 15 is retained in the DreamVest corporate bank account 17 during the second time period 24. Where the client has opted to leave the rebate 15 in the DreamVest corporate bank account, funds from the DreamVest corporate bank account 17 are invested in real estate investment projects until the end of the second time period 24. DreamVest may seek out and obtain additional, outside financing for the various real estate investment projects where considered necessary by DreamVest. Cash reserves and assets on hand as specified by the independent accounting firm 18 and in compliance with tax laws and regulations are retained in the fund/corporate bank account.

During the second time period, the independent, outside accounting firm 18 is asked to conduct audits of the corporate bank account 17, preferably semiannually or annually. Status reports 22 concerning the system 10 are prepared and sent to the system clients, preferably by the independent outside accounting firm 18 on a semiannual or annual basis. Contact information is preferably included in the status report 22 in case the client has any questions. A designated system contact person responds to any questions the client may have, preferably within 24 hours. The DreamVest fund investments are also periodically monitored in-house, preferably on at least a semi-annual basis.

Towards the end of the second time period 24, the corporate representative asks to talk with the client. Where the length of the second time period 24 is ten years, for example, these options are preferably presented to the client about 9.5 years after the date of execution of the second system contract 25. The first option is for the system client to elect to receive the rebate 15 as a lump sum along with any interest that the rebate amount 15 has earned once the second time period 24 ends. Once this is paid to the client at the end of the second time period, the relationship ends.

In the second and third cases described above (see Blocks 123 and 126), the client can be offered the option to continue at the end of the second time period 24 for a third time period 28. The system representative explains that the client may elect to again leave the rebate 15 in the corporate bank account 17 and: a) receive periodic interest payments 26 on the rebate amount 15; or b) roll interest from the rebate amount 15 back into the corporate bank account 17 for further investment in real estate investment projects. The system client may elect to receive the rebate 15 as a lump sum along with any interest that the rebate amount 15 has earned at the end of the third time period 28.

A third system contract 29 is prepared and provided to the client for consideration once the length of the third time period 28 and other terms have been negotiated. The third system contract 29 includes a clause specifying the length of the third time period 28. During the third time period, the rebate amount 15 is invested by DreamVest Corporation, or whichever corporation has been designated to invest the funds. The third system contract 29 may also include a clause concerning any interest payments, where quarterly, semi-annual, or annual interest 26 is to be paid to the client. The third time period 28 is preferably five years. The method can be repeated for third, fourth, etc. time periods, as desired by the system client and the system reinvestment program administrator 27 or other system representative.

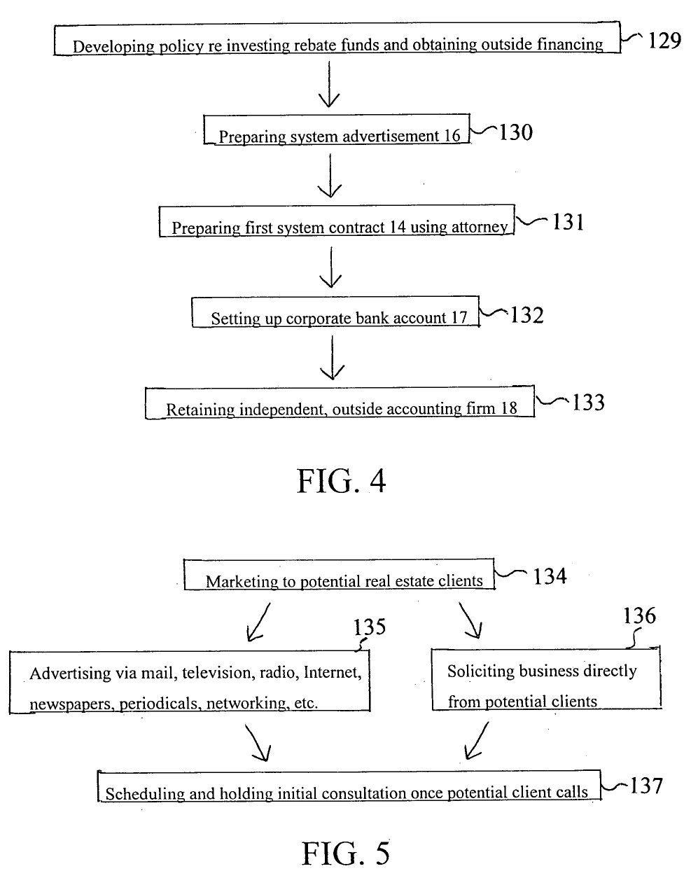

Turning to FIG. 4, the commission reinvestment method 20 comprises several preliminary steps, which include the following:

a) Developing a policy concerning how the program administrator 27 will determine whether and how to invest rebate funds and select real estate projects for investment (which term is meant to include development), and whether and how to obtain additional, outside financing, as seen in Block 129 of FIG. 4;

b) Preparing a system advertisement 16 explaining the mechanics of the system rebate program 12, as seen in Block 130;

c) Preparing the first system contract 14, as seen in Block 131, which includes terms regarding the amount of the system rebate 15 and the first time period 13 of the reinvestment program, preferably using a local tax attorney;

d) Establishing a dedicated corporate bank account 17, as seen in Block 132; and

e) Retaining an independent, outside accounting firm 18 to conduct audits of the corporate bank account 17, as seen in Block 133 of FIG. 4. The audits are preferably semi-annual or annual. Preliminary steps preferably also include: preparing a handout for clients to encourage them to have a separate attorney review all system contracts and other matters prior to signing them.

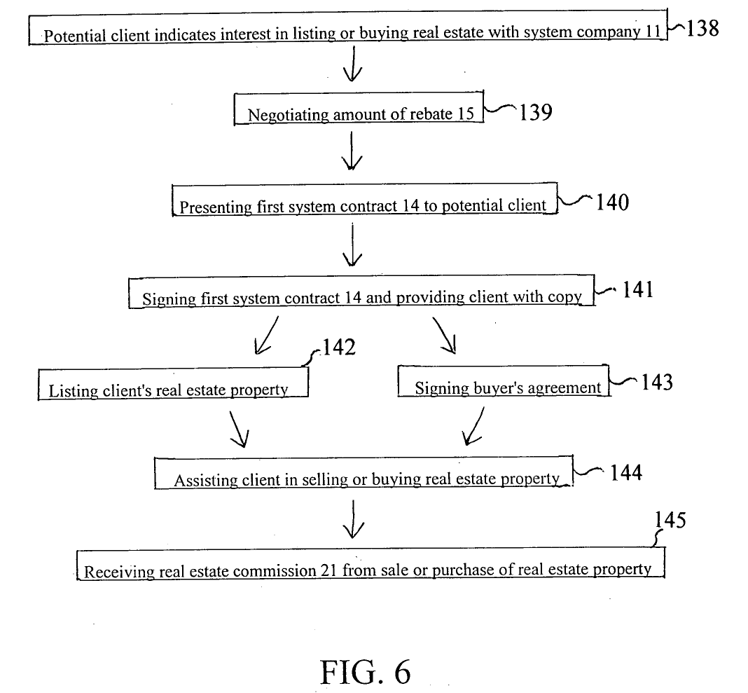

Referring to FIG. 5, the commission reinvestment method 20 includes the following initial steps relating to marketing the realty commission reinvestment program 12:

a) Marketing to potential real estate clients (potential customers), as seen in Block 134; and

b) Scheduling an initial consultation and explaining the reinvestment program 12 to the potential client when the potential client contacts the system realty company 11, preferably DreamVest Realty, to inquire about buying or selling real estate using the system realty company, as seen in Block 137. The first step, marketing to potential real estate clients, preferably includes: 1) Advertising to potential real estate clients via direct mail, television, radio, newspapers, the Internet, periodicals, networking, referrals, etc., as seen in Block 135 of FIG. 5; and 2) Soliciting business directly from potential clients, as seen in Block 136.

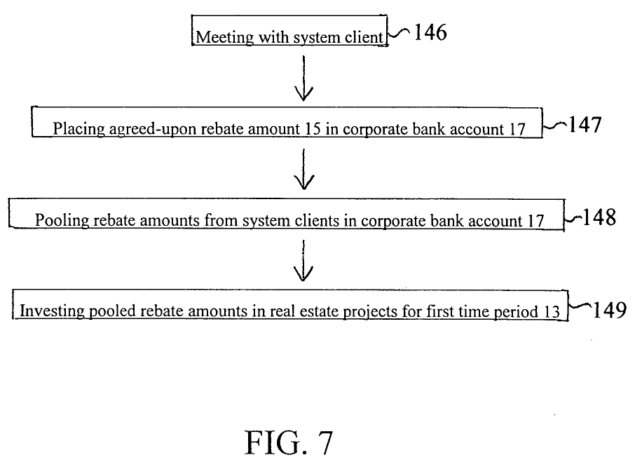

Referring to FIG. 6, the commission reinvestment method 20 includes the following initial steps, once the potential client indicates interest in listing his or her real estate property or buying real estate using the system realty company 11 (Block 138):

a) Negotiating with a potential client what percentage of the commission will be rebated to the client at the end of the first time period 13, as depicted in Block 139 of FIG. 6;

b) Presenting a first system contract 14 along with required real estate related-documents to the potential client once the amount of the rebate 15 has been determined, as depicted in Block 140; and

c) Executing the first system contract 14, and providing the client with a copy of the signed first system contract 14, as depicted in Block 141 of FIG. 6. The first, negotiation step, preferably includes: basing the amount of the rebate 15 on the actual amount of commission received by the system realty company rather than on the amount for the sale of the real estate.

Continuing with FIG. 6, the commission reinvestment method 20 includes the following step relating to sales:

a) Listing the client's real estate property 19 with the system realty company 11, as seen in Block 142, or signing a buyer's agreement, as depicted in Block 143 of FIG. 6; and

b) Assisting the client in selling the subject real estate property or buying the subject real estate property according to the client's expressed desires, as depicted in Block 144 of FIG. 6. For client sellers, this step b) includes: marketing the real estate property 19 using Multiple Listing Services (MLS), newspaper advertisements, magazines, yard signs, etc. For client buyers, this sales step b) includes showing the client potential real estate properties and assisting the client in the transaction process once the client has selected a real estate property 19 to buy.

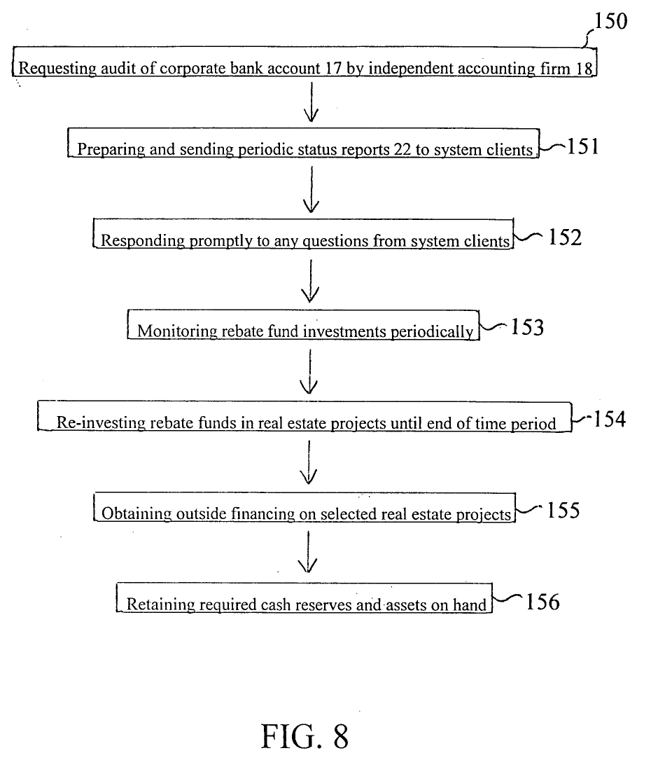

Referring to FIGS. 6 and 7, the commission reinvestment method 20 includes the following steps that relate to closing:

a) Receiving the real estate commission 21 from sale or purchase of the subject real estate property 19 once closing occurs, as seen in Block 145 of FIG. 6;

b) Placing the agreed-upon percentage 15 of the commission in a separate corporate bank account 17, as seen in Block 147, along with any commission percentages (rebate amounts) from any other system clients, as depicted in Block 148; and

c) Investing the rebate amounts (agreed-upon percentage 15 of commission 21), along with any percentages from commissions from other system clients, in the corporate bank account 17 in various real estate investment projects for the first time period 13, as depicted in Block 149 of FIG. 7. The first time period 13 is preferably at least 10 years. The realty commission reinvestment method 20 preferably further includes the step after step a) of: b1) scheduling a meeting and meeting with the client to discuss the matter, as seen in Block 146. At the meeting, the system representative explains again that the agreed-upon percentage 15 of the commission (rebate amount) will be used to finance real estate investment projects, and that the remaining percentage of the commission 21 belongs to the system realty company 11, preferably DreamVest Realty, for work done in completing the real estate transaction. The first step, a) receiving the commission 21, preferably comprises the step of: splitting the real estate commission 21 with any outside real estate agent who contributed to the sale or purchase of the subject real estate property 19, if any.

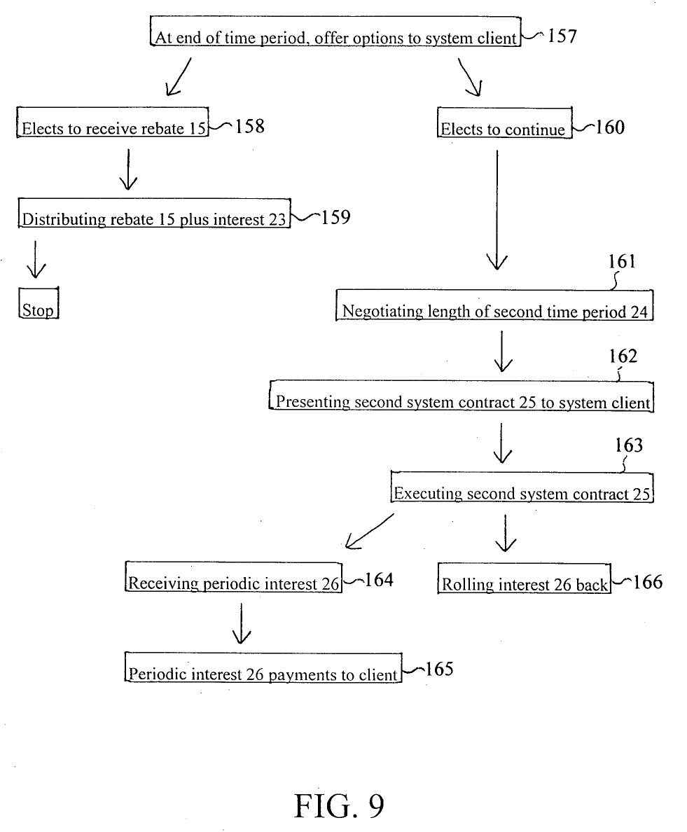

Referring to FIG. 8, the commission reinvestment method 20 includes the following steps, which generally occur after closing:

a) Requesting a periodic audit of the corporate bank account 17, preferably a semiannual or annual audit of a DreamVest Corporation account, by an independent, outside accounting firm 18, as seen in Block 150;

b) Periodically preparing and sending a status report 22 concerning the rebate reinvestment program 12 to update system clients, as seen in Block 151, preferably on a semiannual or annual basis along with contact information in case the client has questions;

c) Responding promptly to any questions system clients may have, as seen in Block 152;

d) Monitoring rebate fund investments periodically, as seen in Block 153;

e) Re-investing rebate funds (the pooled percentages 15 of the commissions 21) from the corporate bank account 17 in various real estate investment projects, or maintaining existing real estate rebate fund investments, until the end of the first time period 13, as seen in Block 154; and

f) Retaining cash reserves and assets on hand, as seen in Block 156, as specified by the independent accounting firm 18 and in compliance with all applicable tax laws and regulations. The order of these steps can be varied. The re-investing funds step e) preferably includes the sub-step of: obtaining additional, outside financing on the various real estate investment projects where considered necessary by the program administrator 27, who is preferably the DreamVest corporate representative, as seen in Block 155 of FIG. 8.

Referring to FIG. 9, the commission reinvestment method 20 further includes the following steps, which generally occur at the end of the first time period 13 (or second time period 24):

a) Rebating an amount equal to the percentage 15 of commission 21 that the system realty company 11, preferably DreamVest Realty, gave on the client's behalf to the client at the end of the first time period 13;

b) Offering the option to the client to either leave the rebate 15 in the corporate bank account 17 for a second time period 24, as seen in Block 160 of FIG. 9, or remove the rebate 15 as a lump sum along with any interest that the rebate amount 15 has earned at the end of the first time period 13, as seen in Block 158 of FIG. 9; and

c) Removing the rebate 15 from the corporate bank account 17 and distributing it to the client along with any interest the rebate amount 15 has earned at the end of the first time period 13, as seen in Block 159 of FIG. 9; or negotiating how long the second time period 24 will be, as seen in Block 161 of FIG. 9, and presenting a second system contract 25 to the client, as seen in Block 162 of FIG. 9, if the client opts to again leave the rebate 15 in the corporate bank account 17.

In step b), offering the option to the client to leave the rebate 15 in the corporate bank account 17 for a second time period 24 includes the sub-steps of: (1) offering periodic interest payments on the rebate 15 to the client; and (2) offering to roll interest from the rebated amount back into the corporate bank account for further investment in real estate investment projects. The system client chooses one of these two options. If the client chooses the first option (1), periodic interest payments 26 on the rebate 15 are made, preferably on a quarterly or semi-annual basis.

Continuing with FIG. 9, the commission reinvestment method 20 further includes the following steps, which generally occur in the second time period 24 where the system client has opted to leave the rebate 15 in the corporate bank account 17, as seen in Block 160:

a) Presenting a second system contract 25 to the system client for consideration, as seen in Block 162, once the length of the second time period 24 has been negotiated, as seen in Block 161;

b) Retaining the rebate amount 15 in the corporate bank account 17 during the second time period 24, as seen in Block 166, once the second system contract 25 is in effect, as seen in Block 163 of FIG. 9;

c) Continuing existing investments or re-investing pooled rebates 15 from the corporate bank account 17 in real estate investment projects until the end of the second time period 24, as seen in Block 154 of FIG. 8;

d) Monitoring system fund investments periodically), as seen in Block 153 of FIG. 8;

e) Requesting a periodic audit of the corporate bank account 17, preferably a semiannual or annual audit of a DreamVest Corporation bank account, by an independent, outside accounting firm 18 during the second time period 24, as seen in Block 150 of FIG. 8;

f) Sending periodic interest payments 26 to system clients who selected that option, as seen in Blocks 164 and 165 of FIG. 9; and

g) Retaining cash reserves and assets on hand as specified by the independent accounting firm 18 and in compliance with all applicable tax laws and regulations, as seen in Block 156 of FIG. 8. The method 20 preferably further includes the step after step b) retaining the rebate of: b2) obtaining additional, outside financing on the real estate projects where necessary, as seen in Block 155 of FIG. 8. The method 20 preferably further includes the step after step c) investments of: c2) periodically preparing and sending a status report 22 concerning the system 10 to update system clients, as seen in Block 156 of FIG. 8, preferably on a semiannual or annual basis along with contact information in case the client has questions. Prompt responses should be supplied for any such questions.

In regard to these second time period steps, the periodic interest payments 26 are preferably made quarterly or semi-annually. The second time period 24 is preferably five years or ten years. The corporate bank account may be with a credit union or the like, and “corporate” may actually refer to an LLC or the like. Lastly, the program administrator 27 determines where and when to invest rebate funds and selects real estate projects for investment or development without input from the system clients. The program administrator 27 determines when and how to obtain additional financing without client input.

Continuing with FIG. 9, the commission reinvestment method 20 further includes the following steps, which occur at the end of the second time period 24 (or the third time period 28):

a) Offering the option to the system client to either: (1) leave the rebate in the corporate bank account 17 for a third time period 28, as seen in Block 160 of FIG. 9; or (2) remove the rebate 15 as a lump sum along with any interest that the rebate amount 15 has earned at the end of the third time period 28, as seen in Block 158 of FIG. 9; and

b) Removing the rebate amount 15 and distributing it to the client along with any interest the rebate amount 15 has earned during the second time period 24, where the second option (2) is elected, as seen in Block 159. Step a) offering the option to leave the rebate 15 in the corporate bank account 17 comprises: (1) Offering periodic interest payments 26 on the rebate 15 to the client, as seen in Block 164 of FIG. 9; or (2) Offering to roll interest from the rebated amount 15 back into the corporate bank account 17 for further investment in real estate projects, as seen in Block 166 of FIG. 9.

Where the client has opted to leave the rebate 15 in the corporate bank account 17 for the third time period 28, the commission reinvestment method 20 further includes the following steps, as depicted in FIGS. 8 and 9 for the second time period:

a) Presenting a third system contract 29 to the client for consideration once the length of the third time period 28 has been negotiated, as depicted in Blocks 161 and 162, respectively, of FIG. 9;

b) Retaining the rebate amount 15 in the corporate bank account 17 during the third time period 28 once the third system contract 29 is in effect;

c) Continuing existing investments or re-investing pooled rebates 15 from the corporate bank account 17 in real estate projects until the end of the third time period 28, as depicted in Block 154 of FIG. 8;

d) Monitoring system fund investments periodically during the third time period 28, as depicted in Block 153 of FIG. 8;

e) Requesting a periodic audit of the corporate bank account 17, preferably a semiannual or annual audit of a DreamVest Corporation account, by an independent, outside accounting firm 18 during the third time period 28, as depicted in Block 150 of FIG. 8;

f) Sending periodic interest payments 26 to system clients who selected that option, as depicted in Block 165 of FIG. 9; and

g) Retaining cash reserves and assets on hand as specified by the independent accounting firm 18 and in compliance with all applicable tax laws and regulations, as depicted in Block 156 of FIG. 8. The method 20 preferably further includes the step after step b) retaining the rebate of: b2) obtaining additional, outside financing on the real estate projects where necessary, as depicted in Block 155 of FIG. 8. The method 20 preferably further includes the step after step c) investments of: c2) periodically preparing and sending a status report 22 concerning the system 10 to update system clients, as depicted in Block 151 of FIG. 8, preferably on a semiannual or annual basis. The third time period 28 is preferably at least five years. The above-described steps of the method 20 can be repeated for additional time periods, as desired by the system client and the system realty company.

As seen in FIGS. 1-3, the real estate commission reinvestment system 10 includes:

a) a policy concerning investment of pooled rebate amounts 15 from the sale or purchase of the real estate property 19 in select real estate investment projects, and obtaining additional, outside financing for the real estate investment projects;

b) a system advertisement 16 explaining the system commission reinvestment program 12;

c) a first system contract 14, as well as a second system contract 25 if the client chooses to continue at the end of the first time period 13;

d) a corporate bank account 17; and

e) an agreement with an independent, outside accounting firm 18 for periodic audits of the corporate bank account 17.

From the foregoing it can be realized that the described method of the present invention may be easily and conveniently utilized as a system and method for reinvesting real estate commissions. While preferred embodiments of the invention have been described using specific terms, this description is for illustrative purposes only. It will be apparent to those of ordinary skill in the art that various modifications, substitutions, omissions, and changes may be made without departing from the spirit or scope of the invention, and that such are intended to be within the scope of the present invention as defined by the following claims. It is intended that the doctrine of equivalents be relied upon to determine the fair scope of these claims in connection with any other person's product which fall outside the literal wording of these claims, but which in reality do not materially depart from this invention. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is:

1. A real estate commission reinvestment method comprising the following steps:
a) Offering a commission reinvestment program according to the real estate commission reinvestment method to a client who is listing or interested in purchasing at least one real estate property using a system realty company;
b) Fixing a rebate amount of the real estate commission that will be transferred to the system realty company once the at least one real estate property is purchased or sold using at least one agent of the system realty company, and then rebated back to the client at the end of a pre-set first time period;
c) Presenting a first system contract to the client;
d) Reviewing and executing the first system contract; and
e) Transferring the rebate amount of the commission from the sale or purchase of the at least one real estate property to a system corporate bank account, and a remainder of the pre-agreed commission to the at least one agent of the system realty company on or after a closing on the at least one real estate property.

2. The method according to claim 1, wherein the rebate amount is a percentage of the commission that is provided to the system realty company once the at least one real estate property is bought or sold, and then rebated back to the client at the end of the time period.

3. The method according to claim 1, further comprising the steps of:
f) Pooling the rebate amounts of the commissions from at least two system program clients in the corporate bank account, each client buying or selling a separate one of the at least one real estate property; and
g) Investing the pooled rebate amounts of the commissions from the corporate bank account in at least one real estate investment project for at least a portion of the first time period.

4. The method according to claim 1, wherein offering step a) further comprises the sub-step of:
a2) Negotiating what percentage of the commission will be transferred to the system realty company once the at least one real estate property is bought or sold, and then rebated back to the client at the end of the first time period.

5. The method according to claim 4, wherein the negotiating step a2) further comprises: basing the amount of the rebate on the actual amount of commission received by the system realty company rather than on the amount for the sale of the at least one real estate property.

6. The method according to claim 3, further comprising the steps after closing of:
a) Requesting a periodic audit of the corporate bank account by an independent, outside accounting firm;
b) Periodically preparing and sending a status report concerning the commission reinvestment program to the client; and
c) Monitoring real estate investment projects periodically.

7. The method according to claim 6, further comprising the step of:
d) Retaining cash reserves and assets on hand as specified by the independent accounting firm and in compliance with applicable laws and regulations.

8. The method according to claim 3, further comprising the step of:
e) Re-investing the pooled rebate amounts from the corporate bank account in an additional one of the real estate investment projects until the end of the first time period.

9. The method according to claim 3, wherein the investing step g) further comprises the sub-step of: g2) obtaining additional, outside financing for the at least one real estate investment project where considered necessary by a program administrator of the commission reinvestment program.

10. The method according to claim 3, wherein the at least one real estate investment property comprises renovating a real estate property.

11. The method according to claim 8, wherein the at least one real estate investment property comprises buying a new real estate property.

12. The method according to claim 1, further comprising preliminary steps prior to offering step a) of:
a) Developing a policy concerning how a program administrator of the commission reinvestment program will invest the pooled rebate amounts and select real estate projects for investment, and whether and how to obtain additional, outside financing;
b) Preparing a system advertisement explaining the system commission reinvestment program;
c) Preparing the first system contract using at least one attorney;
d) Establishing a corporate bank account; and
e) Retaining an independent, outside accounting firm to conduct audits of the corporate bank account.

13. The method according to claim 3, further comprising the following steps, which occur between about nine months and about one month prior to the end of the first time period:
a) Offering the client options of either: (1) leaving the rebate amount in the corporate bank account for a pre-set second time period for continued investment in the at least one real estate investment project; or (2) receiving the rebate amount as a lump sum payment along with any interest that the rebate amount has earned by the end of the first time period.

14. The method according to claim 13, further comprising the sub-steps under step a) (1) of: (1a) offering periodic interest payments on the rebate amount to the client; and (1b) offering to roll interest from the rebate amount back into the corporate bank account for further investment in the at least one real estate investment project.

15. The method according to claim 13, further comprising the step of:
b) Removing the rebate amount from the corporate bank account and distributing it to the client along with any interest the rebate amount has earned at the end of the first time period, upon selection of step a) (2).

16. The method according to claim 13, further comprising the steps of:
b) Presenting a second system contract to the client upon selection of step a) (1), once the length of the second time period has been determined; and
c) Retaining the rebate amount in the corporate bank account during the second time period if the second system contract has been executed.

17. The method according to claim 14, further comprising the step of: e) making periodic interest payments on the rebate amount, where step a) (1a) has been selected.

18. The method according to claim 16, further comprising the step of:
d) Continuing the existing at least one real estate investment project until the end of the second time period.

19. The method according to claim 16, further comprising the step of:
d) Re-investing the pooled rebate amounts in an additional one of the real estate investment projects until the end of the pre-set second time period.

20. A real estate commission reinvestment system, comprising:
a) a policy concerning investment of pooled rebate amounts from the sale or purchase of at least one real estate property in select real estate investment projects, and obtaining additional, outside financing for the real estate investment projects;
b) a system advertisement explaining the system commission reinvestment program;
c) a first system contract;
d) a corporate bank account; and
e) an agreement with an independent, outside accounting firm for periodic audits of the corporate bank account.
